(19) United States
(12) Patent Application Publication
(10) Pub. No.: US 2008/0252472 A1
(43) Pub. Date: Oct. 16, 2008

(54) AUTOMATIC LIQUID LEVEL MONITORING APPARATUS

(75) Inventors: Chih Hsien SU, Kaohsiung City (TW); Yi-Chin TZAI, Taipei County (TW); Kun Feng LEE, Kaohsiung County (TW); Hsi Feng KAO, Taipei County (TW); Ching-Yi WU, Taoyuan County (TW); Yuh-Jiuan LIN, Taipei County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/871,609

(22) Filed: Oct. 12, 2007

(30) Foreign Application Priority Data
Apr. 12, 2007 (TW) TW96112857

(51) Int. Cl. G08B 21/00

(52) U.S. Cl. 340/619

(57) ABSTRACT

An automatic liquid level monitoring apparatus. A flexible circuit board is attached to a resilient base plate. A light transmitter is disposed on and electrically connected to the flexible circuit board. A light detector is disposed on and electrically connected to the flexible circuit board. The light detector opposes the light transmitter. An alarm is disposed on the resilient base plate and electrically connected to the flexible circuit board. A power supply member is electrically connected to the flexible circuit board, supplying power thereto.

### BACKGROUND OF THE INVENTION

1. Field of the Invention

The invention relates to an automatic liquid level monitoring apparatus, and more particularly to an automatic level monitoring apparatus for a drip.

2. Description of the Related Art

Normal saline, nutrition, or other supplement is conventionally introduced into a patient body via an intravenous drip. To avoid void introduction, remainder in the drip or a drip chamber connected thereto must be persistently monitored. Accordingly, recipient of a drip can unconsciously focus on the condition thereof or a drip chamber thereof, causing unnecessary anxiety.

To solve the aforementioned problem, a multi-function drip monitoring device is utilized to automatically monitor the amount of the fluid in the drip chamber. The multi-function drip monitoring device, however, is complicated, bulky, and expensive. Thus, use of the multi-function drip monitoring device, capable of controlling drop flow and providing an alarm, is restricted to intensive care units and is uncommon in ordinary wards.

U.S. Pat. No. 4,583,975 discloses a drop detection apparatus using piezoelectric means and a controller to monitor and control drop injection. The piezoelectric means is mounted on a drip chamber, sensing the pressure by which fluid therein exerts on a wall thereof. Specifically, different levels of the fluid in the drip chamber provide different pressure on the wall thereof. The piezoelectric means senses the pressure or level of the fluid, enabling the controller to output a timely alert. Nevertheless, the drop detection apparatus comprises many components, resulting in inconvenience of operation and costly apparatus.

Hence, there is a need for an automatic liquid level monitoring apparatus easily applied to various vessels and automatically monitoring the level of a liquid therein.

### BRIEF SUMMARY OF THE INVENTION

A detailed description is given in the following embodiments with reference to the accompanying drawings.

An exemplary embodiment of the invention provides an automatic liquid level monitoring apparatus comprising a resilient base plate, a flexible circuit board, a light transmitter, a light detector, an alarm, and a power supply member. The flexible circuit board is attached to the resilient base plate. The light transmitter is disposed on and electrically connected to the flexible circuit board. The light detector is disposed on and electrically connected to the flexible circuit board. The light detector opposes the light transmitter. The alarm is disposed on the resilient base plate and electrically connected to the flexible circuit board. The power supply member is electrically connected to the flexible circuit board, supplying power thereto.

The alarm comprises a sound-emitting element or a light-emitting element.

The power supply member is detachably connected to the resilient base plate.

The resilient base plate comprises a recess accommodating the power supply member.

Another exemplary embodiment of the invention provides an automatic liquid level monitoring apparatus comprising a flexible circuit board, a resilient base plate, a light transmitter, a light detector, an alarm, and a power supply member. The flexible circuit board surrounds a vessel. The resilient base plate is attached to and surrounds the flexible circuit board. The light transmitter is disposed on and electrically connected to the flexible circuit board. The light detector is disposed on and electrically connected to the flexible circuit board. The light detector opposes the light transmitter. The alarm is disposed on the resilient base plate and electrically connected to the flexible circuit board. The power supply member is electrically connected to the flexible circuit board, supplying power thereto.

Yet another exemplary embodiment of the invention provides an automatic liquid level monitoring apparatus comprising a resilient base plate, a flexible circuit board, a light transmitter, a light detector, an alarm, and a power supply member. The resilient base plate is surrounded by a vessel. The flexible circuit board is attached to and surrounded by the resilient base plate. The light transmitter is disposed on and electrically connected to the flexible circuit board. The light detector is disposed on and electrically connected to the flexible circuit board. The light detector opposes the light transmitter. The alarm is disposed on the resilient base plate and electrically connected to the flexible circuit board. The power supply member is electrically connected to the flexible circuit board, supplying power thereto.

The power supply member is connected to the resilient base plate.

### BRIEF DESCRIPTION OF THE DRAWINGS

The invention can be more fully understood by reading the subsequent detailed description and examples with references made to the accompanying drawings, wherein:

FIG. 1 is a schematic perspective view of an automatic liquid level monitoring apparatus of the invention;

FIG. 2A is a perspective expanded view of FIG. 1;

FIG. 2B is another perspective expanded view of FIG. 1;

FIG. 3 is a schematic view showing application of an automatic liquid level monitoring apparatus of a first embodiment of the invention; and

FIG. 4 is a schematic view showing application of an automatic liquid level monitoring apparatus of a second embodiment of the invention.

### DETAILED DESCRIPTION OF THE ILLUSTRATED EMBODIMENT

The following description is made for the purpose of illustrating the general principles of the invention and should not be taken in a limiting sense. The scope of the invention is best determined by reference to the appended claims.

### First Embodiment

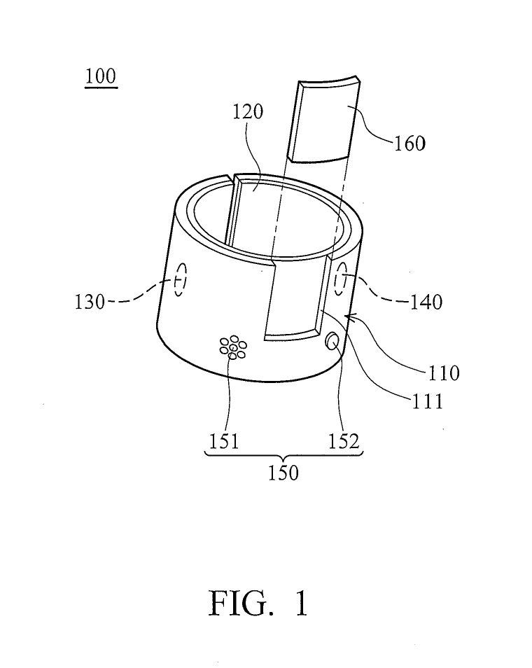

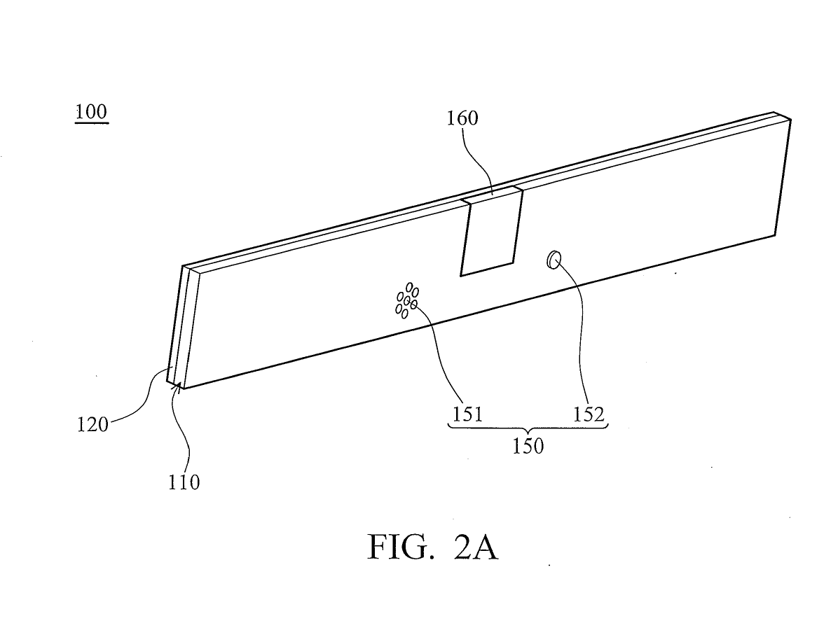

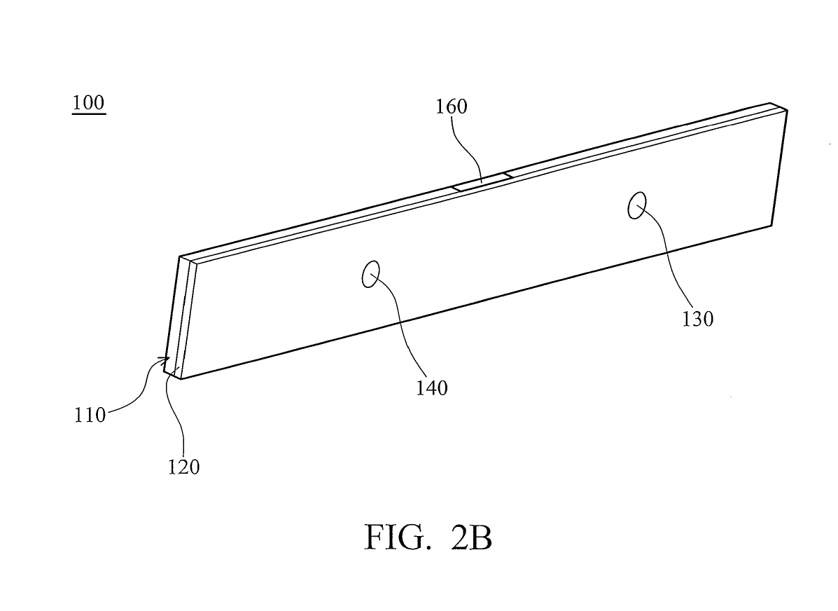

Referring to FIGS. 1, 2A, 2B, an automatic liquid level monitoring apparatus 100 comprises a resilient base plate 110, a flexible circuit board 120, a light transmitter 130, a light detector 140, an alarm 150, and a power supply member 160.

The resilient base plate 110 comprises a recess 111 (as shown in FIG. 1). In this embodiment, the resilient base plate 110 may comprise elastically deformable material, such as silica gel.

The flexible circuit board 120 is attached to the resilient base plate 110 and comprises a control circuit (not shown).

The light transmitter 130 is disposed on and electrically connected to the flexible circuit board 120. In this embodiment, the light transmitter 130 may output infrared light, laser, or visible light. Namely, the light transmitter 130 may comprise an IR LED, a laser LED, or an LED. Additionally, the light transmitter 130 may continuously or intermittently output light.

The light detector 140 is disposed on and electrically connected to the flexible circuit board 120. Specifically, as shown in FIG. 1, the light detector 140 opposes the light transmitter 130, receiving the light from the light transmitter 130.

The alarm 150 is disposed on the resilient base plate 110 and electrically connected to the flexible circuit board 120. In this embodiment, the alarm 150 comprises a sound-emitting element 151 and a light-emitting element 152. The sound-emitting element 151 may be a buzzer and the light-emitting element 152 may be an LED or a bulb.

The power supply member 160 is electrically connected to the flexible circuit board 120, supplying power thereto. Specifically, the power supply member 160 may be directly connected to the resilient base plate 110 or flexible circuit board 120. In this embodiment, the power supply member 160 is detachably connected to the resilient base plate 110 and accommodated in the recess 111 thereof, such that the power supply member 160 can be easily replaced. Additionally, the power supply member 160 may be a cell.

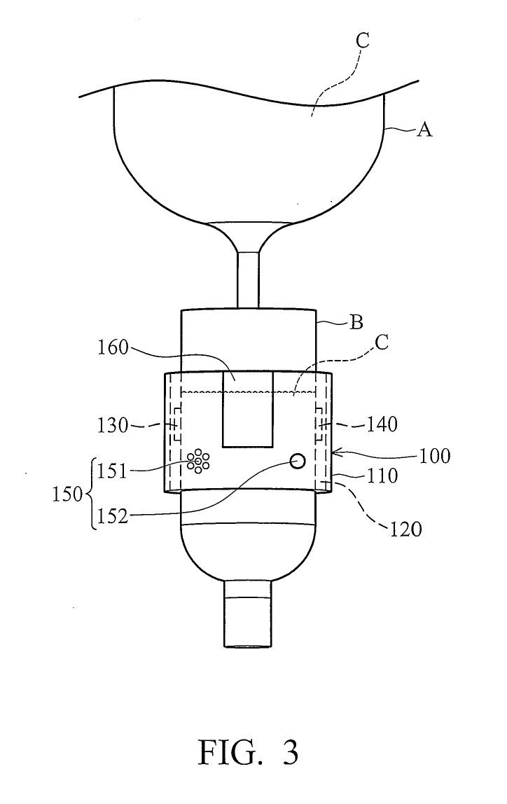

Accordingly, the automatic liquid level monitoring apparatus 100 can be applied to automatically monitor the level of a liquid in a vessel and output corresponding alerts. For example, as shown in FIG. 3, a drip comprises a drip container A and a drip chamber B connected thereto. Fluid C drops from the drip container A into the drip chamber B. The fluid C is then introduced into a patient body from the drip chamber B. To avoid scarcity of the fluid C, the level thereof in the drip chamber B must be monitored.

The following description is directed to monitoring of the level of the fluid C in the drip chamber B using the automatic level monitoring apparatus 100.

The automatic liquid level monitoring apparatus 100 properly surrounds the drip chamber B. Here, the flexible circuit board 120 of the automatic liquid level monitoring apparatus 100 surrounds the outer wall of the drip chamber B in a proper height or position, and the resilient base plate 110 thereof surrounds the flexible circuit board 120, as shown in FIG. 3. At this point, the light detector 140 opposes the light transmitter 130. Namely, the light detector 140 and light transmitter 130 are respectively located on opposite sides of the outer wall of the drip chamber B.

When the level of the fluid C is within a desirable range in the drip chamber B (namely, the level of the fluid C is higher than the light detector 140 and light transmitter 130), as shown in FIG. 3, light output from the light transmitter 130 is refracted by the fluid C and thereby cannot be received by the light detector 140. At this point, the control circuit in the flexible circuit board 120 determines that the level of the fluid C is within the desirable range in the drip chamber B, thus not activating the alarm 150.

In another aspect, when the level of the fluid C is scarce in the drip chamber B (namely, the level of the fluid C is lower than the light detector 140 and light transmitter 130), the light output from the light transmitter 130 is directly received by the light detector 140. At this point, the control circuit in the flexible circuit board 120 determines that the level of the fluid C is scarce in the drip chamber B, thus forcing the alarm 150 to output an alert. Namely, the control circuit in the flexible circuit board 120 drives the sound-emitting element 151 and/or light-emitting element 152 to output alert sound and/or light, announcing the need for replenishment of the fluid C or replacement of the drip container A.

Accordingly, the automatic liquid level monitoring apparatus 100 can be repeatedly utilized and is not required to be discarded with the drip chamber B.

Moreover, when lacking power, the power supply member 160 can be replaced without replacing the entire automatic liquid level monitoring apparatus 100.

Additionally, while providing the sound-emitting element 151 and light-emitting element 152, the automatic liquid level monitoring apparatus 100 may selectively provide only one of the sound-emitting element 151 and light-emitting element 152.

Furthermore, the light transmitter 130 and light detector 140 are not limited to being disposed on the flexible circuit board 120. In other words, the light transmitter 130 and light detector 140 may be disposed on the resilient base plate 110 and as well electrically connected to the flexible circuit board 120.

### Second Embodiments

Elements corresponding to those in the first embodiment share the same reference numerals.

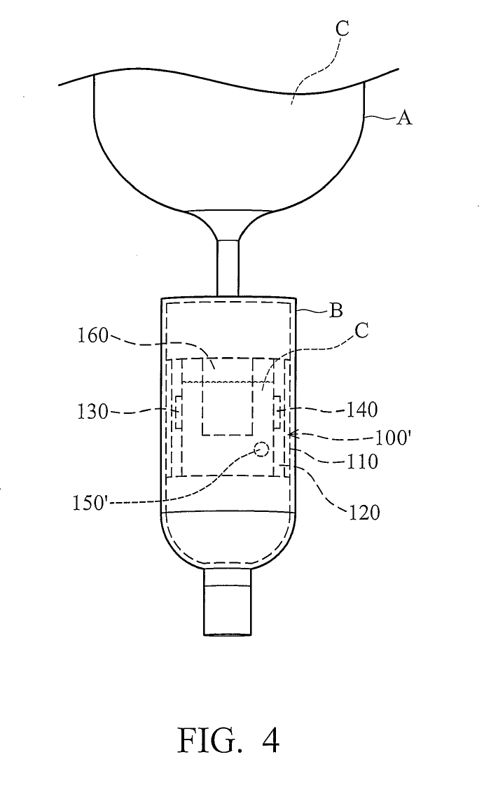

Referring to FIG. 4, an automatic liquid level monitoring apparatus 100′ comprises a resilient base plate 110, a flexible circuit board 120, a light transmitter 130, a light detector 140, an alarm 150′, and a power supply member 160.

In this embodiment, the alarm 150′ comprises a light-emitting element, such as an LED or a bulb. The power supply member 160 is directly connected to the resilient base plate 110.

Structure, disposition, and function of other elements in this embodiment are the same as those in the first embodiment, and explanation thereof is omitted for simplicity.

Similarly, the automatic liquid level monitoring apparatus 100′ can be applied to automatically monitor the level of a liquid in a vessel and output corresponding alerts.

The following description is directed to monitoring of the level of the fluid C in the drip chamber B using the automatic liquid level monitoring apparatus 100′.

As shown in FIG. 4, the automatic level monitoring apparatus 100′ is properly disposed in and attached to the drip chamber B, i.e. inlaid in the drip chamber B. Here, the resilient base plate 110 of the automatic liquid level monitoring apparatus 100′ is surrounded by the inner wall of the drip chamber B, and the flexible circuit board 120 thereof is surrounded by the resilient base plate 110 and located in a proper height or position in the drip chamber B. Similarly, the light detector 140 opposes the light transmitter 130.

When the level of the fluid C is within a desirable range in the drip chamber B (namely, the level of the fluid C is higher than the light detector 140 and light transmitter 130), as shown in FIG. 4, light output from the light transmitter 130 is refracted by the fluid C and thereby cannot be received by the light detector 140. At this point, the control circuit in the flexible circuit board 120 determines that the level of the fluid C is within the desirable range in the drip chamber B, thus not activating the alarm 150′.

In another aspect, when the level of the fluid C is scarce in the drip chamber B (namely, the level of the fluid C is lower than the light detector 140 and light transmitter 130), the light output from the light transmitter 130 is directly received by the light detector 140. At this point, the control circuit in the flexible circuit board 120 determines that the level of the fluid C is scarce in the drip chamber B, thus forcing the alarm 150′ to output an alert. Namely, the control circuit in the flexible circuit board 120 drives the light-emitting element of the alarm 150′ to output alert light, announcing the need for replenishment of the fluid C or replacement of the drip container A.

Accordingly, inlaid in the drip chamber B, the automatic level monitoring apparatus 100′ can be discarded together with the drip chamber B.

Similarly, the light transmitter 130 and light detector 140 are not limited to being disposed on the flexible circuit board 120. In other words, the light transmitter 130 and light detector 140 may be disposed on the resilient base plate 110 and as well electrically connected to the flexible circuit board 120.

In conclusion, the disclosed automatic liquid level monitoring apparatus provides many advantages. Providing flexibility, the automatic level monitoring apparatus can be easily applied to various vessels, monitoring the level of liquids therein and outputting corresponding alerts. Moreover, the automatic liquid level monitoring apparatus provides simplified components, such that manufacturing costs and size thereof are reduced. Thus, the automatic liquid level monitoring apparatus can be widely applied in common hospitals and clinics, promoting quality of medical service and facilitating medical care.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic liquid level monitoring apparatus, comprising:
a resilient base plate;
a flexible circuit board attached to the resilient base plate;
a light transmitter disposed on and electrically connected to the flexible circuit board;
a light detector disposed on and electrically connected to the flexible circuit board, wherein the light detector opposes the light transmitter;
an alarm disposed on the resilient base plate and electrically connected to the flexible circuit board; and
a power supply member electrically connected to the flexible circuit board, supplying power thereto.

2. The automatic liquid level monitoring apparatus as claimed in claim 1, wherein the alarm comprises a sound-emitting element.

3. The automatic liquid level monitoring apparatus as claimed in claim 1, wherein the alarm comprises a light-emitting element.

4. The automatic liquid level monitoring apparatus as claimed in claim 1, wherein the power supply member is detachably connected to the resilient base plate.

5. The automatic liquid level monitoring apparatus as claimed in claim 4, wherein the resilient base plate comprises a recess accommodating the power supply member.

6. An automatic liquid level monitoring apparatus, comprising:
a flexible circuit board surrounding a vessel;
a resilient base plate attached to and surrounding the flexible circuit board;
a light transmitter disposed on and electrically connected to the flexible circuit board;
a light detector disposed on and electrically connected to the flexible circuit board, wherein the light detector opposes the light transmitter;
an alarm disposed on the resilient base plate and electrically connected to the flexible circuit board; and
a power supply member electrically connected to the flexible circuit board, supplying power thereto.

7. The automatic liquid level monitoring apparatus as claimed in claim 6, wherein the alarm comprises a sound-emitting element.

8. The automatic liquid level monitoring apparatus as claimed in claim 6, wherein the alarm comprises a light-emitting element.

9. The automatic liquid level monitoring apparatus as claimed in claim 6, wherein the power supply member is detachably connected to the resilient base plate.

10. The automatic liquid level monitoring apparatus as claimed in claim 9,
wherein the resilient base plate comprises a recess accommodating the power supply member.

11. An automatic liquid level monitoring apparatus, comprising:
a resilient base plate surrounded by a vessel;
a flexible circuit board attached to and surrounded by the resilient base plate;
a light transmitter disposed on and electrically connected to the flexible circuit board;
a light detector disposed on and electrically connected to the flexible circuit board, wherein the light detector opposes the light transmitter;
an alarm disposed on the resilient base plate and electrically connected to the flexible circuit board; and
a power supply member electrically connected to the flexible circuit board, supplying power thereto.

12. The automatic liquid level monitoring apparatus as claimed in claim 11, wherein the alarm comprises a light-emitting element.

13. The automatic liquid level monitoring apparatus as claimed in claim 11, wherein the power supply member is connected to the resilient base plate.

14. An automatic liquid level monitoring apparatus, comprising:
a resilient base plate;
a flexible circuit board attached to the resilient base plate;
a light transmitter disposed on and electrically connected to the flexible circuit board;
a light detector disposed on and electrically connected to the flexible circuit board;
an alarm disposed on the resilient base plate and electrically connected to the flexible circuit board; and
a power supply member electrically connected to the flexible circuit board, supplying power thereto.

15. The automatic liquid level monitoring apparatus as claimed in claim 14, wherein the alarm comprises a sound-emitting element.

16. The automatic liquid level monitoring apparatus as claimed in claim 14, wherein the alarm comprises a light-emitting element.

17. The automatic liquid level monitoring apparatus as claimed in claim 14, wherein the power supply member is detachably connected to the resilient base plate.

18. The automatic liquid level monitoring apparatus as claimed in claim 17, wherein the resilient base plate comprises a recess accommodating the power supply member.
